(19) United States
(12) Patent Application Publication
(10) Pub. No.: US 2004/0260637 A1
(43) Pub. Date: Dec. 23, 2004

(54) Method for aligning investor and portfolio manager financial interests

(76) Inventors: Jeffrey Charles Trewella, Kennett Square, PA (US); Michael Paul Dever, Thornton, PA (US); Anthony Joseph Fischer, Audubon, PA (US)

Correspondence Address: FROST BROWN TODD, LLC, 2200 PNC CENTER, 201 E. FIFTH STREET, CINCINNATI, OH, 45202, US

(21) Appl. No.: 10/463,650

(22) Filed: Jun. 17, 2003

(51) Int. Cl. G06F 17/60

(52) U.S. Cl. 705/36

(57) ABSTRACT

A method for aligning investor and portfolio manager interest comprising a polyfunctional fee algorithm, wherein said algorithm charges higher fees to the investor when returns are favorable and charges a lower fees to the investor when returns are not favorable.

### CROSS-REFERENCE TO RELATED APPLICATIONS

Not Applicable

### STATEMENT REGARDING FEDERALLY SPONSORED RESEARCH FOR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention is related to the field of cost/price determination. Financial service providers and especially some low fee mutual funds have recently focused a great deal of attention on the importance of fees to the overall performance of an investor's portfolio. Fortin and Michelson conducted a comprehensive study comparing actively managed mutual funds to their corresponding index (Fortin, Rich and Michelson, Stuart, “Fund Indexing Vs. Active Management: The Results Are . . . , J of Financial Planning, February, 1999). In this study the average performance of funds in each of seven investment categories was compared to the performance of the corresponding index over five different holding periods ranging from one to fifteen years. For 25 of the 35 combinations the comparison indicated that the index statistically significantly outperformed the average of the actively managed funds.

Kuhle and Pope have evaluated the one-, five-, and ten-year performance of load vs. no load funds for periods ending in 1993 through 1997 (Kuhle, James and Pope, Ralph, “A Comprehensive Long-Term Performance Analysis of Load Vs. No-Load Mutual Funds”, J. of Financial and Strategic Decisions, 13(2), 2000). They found that the only time that the load funds out-performed the no load fund in a statistically significant manner was for the one-year period ending in 1993.

These studies augur that investors should give preference to funds that charge low fees. However this conclusion is based on studies of mutual funds that charge fees or loads that are either a constant percentage of the level of funds invested or that these fees vary only slightly due to minor fluctuations in expenses associated with operating the portfolio.

Alternatively, most hedge funds structure fee schedules such that a portion of the fees is linearly dependent on portfolio performance. In addition to a flat “management fee” these managers often charge a performance-based “incentive fee”. In this way the incentive fee portion of these managers' compensation is directly and linearly dependent on the performance of the portfolio they manage and thereby the interests of their investors.

However, investing in hedge funds that charge performance-based incentive fees is currently limited by statute to only those investors that are classified by SEC guidelines as “qualified clients”. Unfortunately most investors do not meet any of the criteria to be classified as “qualified clients”. For example, they do not invest at least $750,000 with the investment advisor or have a net worth more than $1,500,000, or they are not an employee of an investment advisory firm (see: http://www.law.uc.edu/CCL/InvAdvRIs/rule205-3.html).

Recognizing the opportunity to offer a similar fee structure to ordinary investors, a limited number of open-ended investment companies have begun to offer a fee schedule in which a portion of the fees are adjusted based on the portfolio's performance relative to the performance of a pre-determined benchmark during the same period of time. This fee algorithm is often referred to as a “fulcrum fee”. Using the SEC's EDGAR database, the following funds were identified as using this type of fee structure: Birmiwal Oasis Fund, The India Technology Fund, Franklin Strategic Series, Bear Stearns Select Funds, Hirtle Callaghan Cap Guardian, Hirtle Callaghan Artisan, Hirtle Callaghan Sterling John, and Accessor Funds—Wellington (see: http://www.sec.gov/edgar/searchedgar/webusers.htm). In each of these cases the fulcrum fee algorithms are linear, with the fee calculated from relative performance using a fee schedule that is derived from a single linear equation.

Investment returns usually do not follow a normal distribution. Based on a study of 161 sets of observations for the period 1937 through 1993, Rom and Ferguson determined with 95% confidence that returns did not follow a normal distribution 60.9% of the time (Rom, Brian and Ferguson, Kathleen, “Are Asset Returns Normally Distributed? An Analysis of the Distributional Characteristics of Stocks, Bonds, Bills”, A Research Report from Sponsor-Software Systems, Inc., March, 1995). They reported that 33.5% of the observations exhibited statistically significant kurtosis and skew, 13.7% of the observations exhibited statistically significant kurtosis only, and 13.5% of the observations exhibited statistically significant skew only. Kat studied the monthly return data for the S&P 500 over the period June 1994 through May 2001 and found the distribution to have a kurtosis of 3.05 and a skew of −0.82 (Kat, Harry, “Managed Futures and Hedge Funds: A Match Made in Heaven”, November, 2002).

A positive kurtosis is indicative of “fat tails” relative to a normal distribution and compared to a normal distribution with the same mean and standard deviation indicates a higher probability of a monthly return being far from the mean. A large negative skew represents an asymmetric distribution relative to a normal distribution and a higher probability of a negative monthly return being far from the mean than a positive monthly return being far from the mean.

With the distribution of returns characterized by a positive kurtosis and a negative skew, the probability of a very poor return exceeds the probability of similar size positive return.

Given this distribution of typical portfolio returns, it would be advantageous to an investor to compensate for this distribution by adjusting portfolio manager fees according to a polyfunctional algorithm. Further, it would be more advantageous to establish the functional form and coefficients of each of the multiple functions to compensate for skew and kurtosis.

Hedge funds do not reduce their total fees below the flat “management fee” during periods when they under-perform a predetermined target performance level such as 0.75% per month. Nor do hedge funds reduce their total fees below the flat “management fee” during periods when they under-perform a benchmark such as the S&P 500 or the 90-Day Treasury Bill Index.

The “fulcrum fee” structure used by some mutual funds is based on a single linear equation, and therefore does not provide for optimum portfolio performance.

It would be desirable to provide alignment of manager and investor interest; wherein a portion of the fees charged by the manager is dependent on portfolio performance according to a polyfunctional algorithm.

In addition in order to reduce the volatility of returns, it would be desirable to minimize or entirely eliminate portfolio manager compensation fees during periods of poor portfolio performance.

Likewise, to retain top managers, it would be desirable to reward managers with higher fees when portfolio performance is strong.

A business method has been developed to provide alignment of manager and investor interest; wherein a portion of the fees charged by the manager is dependent on portfolio performance according to a polyfunctional algorithm.

### BRIEF SUMMARY OF THE INVENTION

We have invented a business method that can help solve the three problems stated above, namely providing a positive incentive for the portfolio manager to produce good returns, reducing the kurtosis of the distribution of net returns to the investor, and increasing the skew of the distribution of net returns to the investor.

One embodiment of the present invention is a method for increasing the fee paid to a portfolio manager when returns are favorable and decreasing the fee paid to a portfolio manager when returns are not favorable.

Another embodiment of the present invention is a method for reducing the standard deviation or volatility of the distribution of net returns received by the investor.

Another embodiment of the present invention is a method for reducing the kurtosis of the distribution of net returns received by the investor.

Another embodiment of the present invention is a method for increasing the skew of the distribution of net returns received by the investor.

### BRIEF DESCRIPTION OF THE SEVERAL VIEWS OF THE DRAWING

Not Applicable

### DETAILED DESCRIPTION OF THE INVENTION

According to the invention, a method is proposed for aligning investor and portfolio manager interest having a fee algorithm comprising a plurality of functions wherein said algorithm charges higher fees to an investor when returns are favorable during a predefined time period and charges lower fees to an investor when returns are not favorable during a predefined time period. This involves a novel and unique approach altogether different from the ceiling/floor arrangements used by some portfolio managers.

In one embodiment of the invention, a value, Δ, is determined by calculating the difference between the gross portfolio return compared to a reference return of comprising a pre-selected target such as 0.5%/month or a pre-selected index, such as the 90-Day Treasury Bill, S&P 500, Russell Value Index; a pre-selected exchange traded fund such as SPY, QQQ; a pre-selected individual equity such as MSFT, or GE; and the like during the same time period according to equation (1).

Δ=portfolio return−reference return (Eq 1)

If Δ is greater than or equal to zero for that time period, a fee is calculated according to equation (2).

Fee=aᵢ+bᵢ*Δ (Eq 2)

If Δ is less than zero for that time period, a fee is calculated according to equation (3).

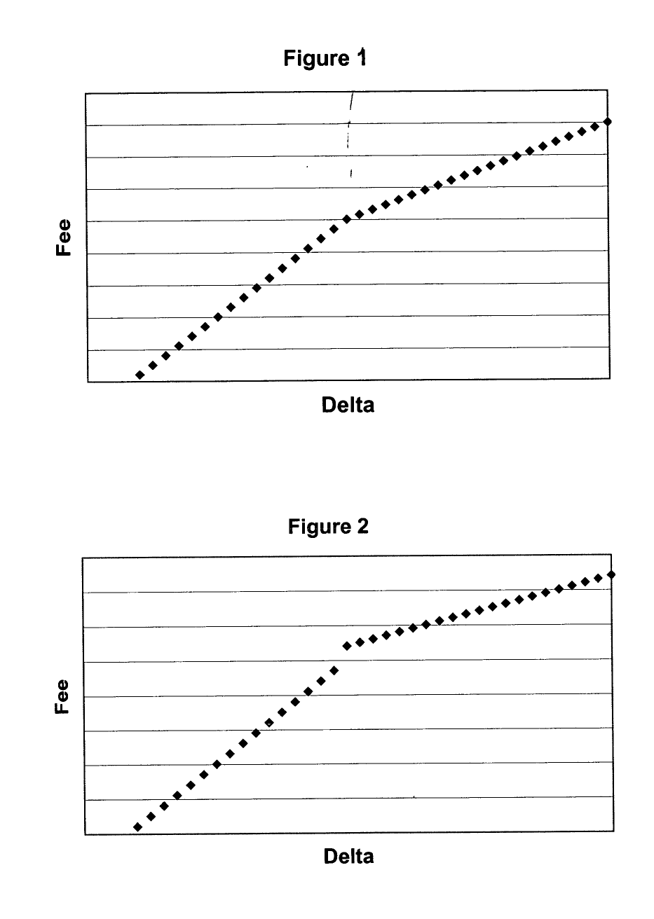

Fee=aᵢᵢ+bᵢᵢ*Δ (Eq 3)

Wherein bᵢ does not equal bᵢᵢ but aᵢ does equal aᵢᵢ. Accordingly, the portfolio manager receives a different rate of compensation depending upon whether Equations (2) or (3) are used. It is also contemplated that aᵢ and aᵢᵢ can be different. Depending on the units of coefficients aᵢ aᵢᵢ bᵢ and bᵢᵢ, the fee may be in units of dollars or a percentage. Equations (2) and (3) together serve as an example of a plurality of functions of the present invention. FIG. 1 (Fee vs. Δ) illustrates an example of the present invention.

Such a method provides a benefit to an investor of improving the distribution of net returns by reducing the standard deviation or volatility of net returns received by an investor after fees are paid to the portfolio manager. When returns are favorable a first function charges a higher fee, thereby reducing the net return received by an investor. In a similar but opposite sense, when returns are not favorable a second function charges a lower fee, thereby increasing the net return received by an investor compared to had the first function been used. In combination, these two functions serve to narrow the distribution, thereby reducing the standard deviation or volatility of the distribution of net returns received by an investor.

A further benefit is obtained by reducing the kurtosis of the distribution of net returns received by the investor.

A further benefit is obtained by increasing the skew of the distribution of net returns received by the investor.

As those skilled in the art can imagine, the method of the present invention can be applied using other functions or algorithms.

As an example, the inventors have applied the method of the present invention to monthly returns on the S&P 500 during the period January 1992 through April 2003. According to the present invention, for each month Δ was calculated according to equation (1) using that month's 90-Day Treasury Bill Index as the reference return. Then as described above depending on the value of Δ for each month, a fee was calculated using either equation (2) or equation (3).

Table 1 illustrates the results for various values of aᵢ bᵢ aᵢᵢ and bᵢᵢ.

TABLE 1
Fee Structure Parameters and Return Statistics

| | Ex 1 | Ex 2 | Ex 3 | Ex 4 | Ex 5 | Ex 6 |
|---|---|---|---|---|---|---|
| aᵢ | 0.00% | 0.25% | 0.25% | 0.25% | 0.25% | 0.30% |
| bᵢ | 0.00% | 30.0% | 38.0% | 69.0% | 84.5% | 38.0% |
| aᵢᵢ | 0.00% | 0.25% | 0.25% | 0.25% | 0.25% | 0.25% |
| bᵢᵢ | 0.00% | 30.0% | 40.0% | 80.0% | 100.0% | 40.0% |
| Monthly Net | 0.84% | 0.69% | 0.69% | 0.69% | 0.70% | 0.69% |
| Return Average | | | | | | |
| Monthly Net | 4.31% | 3.02% | 2.64% | 1.11% | 0.40% | 2.64% |
| Return S.D. | | | | | | |
| Monthly Net | −0.561 | −0.572 | −0.536 | −0.113 | 0.726 | −0.536 |
| Return Skew | | | | | | |
| Monthly Net | 0.578 | 0.585 | 0.521 | −0.079 | −0.108 | 0.518 |
| Return Kurtosis | | | | | | |
| Annualized | 9.36% | 8.06% | 8.16% | 8.57% | 8.66% | 8.13% |
| Net Return | | | | | | |
| Average | 0.00% | 0.15% | 0.15% | 0.15% | 0.15% | 0.15% |
| Monthly Fee | | | | | | |

“Express Mail” Mailing Label No.: EV316083068US

Examples 1 and 2 are provided for reference and are not examples of the present invention. Example 1 shows the return statistics for a case wherein no fees are charged. In Example 2 illustrates the return statistics for a mono-functional fulcrum fee structure known in the prior art. In this example, since all the coefficients and functional form of equations (2) and (3) are identical, the fulcrum fee structure reduces to equation (2) alone.

Examples 3, 4, 5, and 6 are examples of the present invention wherein fees are calculated using a plurality of functions. In each of these examples although equations (2) and (3) have the same functional form, a least one of the coefficients is different. In Example 6 equations (2) and (3) have the same functional form, and all of the coefficients are different.

Unexpectedly, although the average monthly fee paid by the investor is 0.15% for both Example 2 (prior art) and Example 3, the net annualized return to the investor is higher for the method of the present invention. A further benefit of the present invention is the lower standard deviation (SD) of 2.64% (Example 3) vs. 3.02% (Example 2, prior art). A further benefit of the present invention is the higher skew of −0.536 (Example 3) vs. −0.572 (Example 2, prior art). A further benefit of the present invention is the lower kurtosis of 0.521 (Example 3) vs. 0.585 (Example 2, prior art). A further benefit of the present invention is that the portfolio manager receives a higher fee payment when Δ (equation 1) is greater than zero, thereby aligning investor and portfolio manager interest.

Compared to the prior art illustrated in Example 2, Example 4 further illustrates benefits of the present invention, namely reduced standard deviation, increased skew and reduced kurtosis of the distribution of net returns received by the investor.

Compared to the prior art illustrated in Example 2, Example 5 further illustrates benefits of the present invention, namely reduced standard deviation, increased skew and reduced kurtosis of the distribution of net returns received by the investor.

Compared to the prior art illustrated in Example 2, Example 6 further illustrates benefits of the present invention, namely reduced standard deviation, increased skew and reduced kurtosis of the distribution of net returns received by the investor. FIG. 2 (Fee vs. Δ) illustrates an example of the present invention wherein all of the coefficients of equations (2) and (3) are different.

As those skilled in the art can imagine, the method of the present invention can be applied using other equations.

While the previous examples have shown linear equations, it is also contemplated that equations can be of higher order including, without limitation, quadratic, power, log, inverse, and the like. It is also contemplated that that the equations can be of different functional form. For example, a linear equation such at equation (2) can be used to calculate fees if Δ is greater than or equal to a given value for that time period, and a quadratic equation can be used to calculate fees if Δ is less than said given value for that time period. Additional steps may be conducted in order to practice the present invention.

In one preferred embodiment, according to the present invention, for each month Δ was calculated according to equation (1) using that month's 90-Day Treasury Bill index return. Then as described above, a fee was calculated using either equation (2) or equation (3), depending on the value of Δ for each month, wherein aᵢ is between 0 and 0.5%, preferably between 0% and 0.25% and more preferably between 0% and 0.17%; bᵢ is between 0 and 40%, preferably between 5% and 30% and more preferably between 10% and 25%; a_{ii is} between 0 and 0.5%, preferably between 0% and 0.25% and more preferably between 0% and 0.17%; and bᵢᵢ is between 50 and 1000%, preferably between 75% and 1000% and more preferably between 200% and 1000%.

Those skilled in the art will recognize that the present invention can be modified in a number of ways without deviating from the practice of the present invention. For example in some instances it may be desirable to use a more complex algorithm to select from among fee calculating equations. For example, equations (1) could be replaced with equation (4)

Δ=cᵢ*portfolio return−cᵢᵢ*index return (Eq 4)

wherein cᵢ and cᵢᵢ are scalars.

Those skilled in the art will also recognize that the benefits from using more than two equations to calculate fees, namely the enhanced ability to shape the distribution of net returns. For example, if Δ is greater than or equal to a first threshold in a given time period, a fee is calculated according to equation (5).

Fee=aᵢ+bᵢ*Δ (Eq 5)

If Δ is less than or equal to a second threshold in a given time period, a fee is calculated according to equation (6).

Fee=aᵢᵢ+bᵢᵢ*Δ (Eq 6)

If Δ is less than said first threshold and greater than said second threshold in a given time period, a fee is calculated according to equation (7).

Fee=aᵢᵢᵢ+bᵢᵢᵢ*Δ (Eq 7)

Likewise, it may be desirable to calculate fees using at least one higher order equation according to techniques well known in the art.

What is claimed is:

1. A method for aligning investor and portfolio manager interest having a fee algorithm comprising a plurality of functions wherein said algorithm charges a higher fee to an investor when a portfolio return is favorable during a predefined time period and charges a lower fee to an investor when a portfolio return is not favorable during a predefined time period.

2. The method according to claim 1, wherein the favorable return is based on said return exceeding the return of a predetermined reference investment.

3. A method for aligning investor and portfolio manager interest using a plurality of functions, the method comprising the steps of:
a) calculating the difference between the return of portfolio managed by the portfolio manager over a period of time against a reference return;
b) determining from the calculated difference between the return of the managed portfolio against the reference return whether the return of the managed portfolio was favorable or not favorable;
c) if the return of the managed portfolio is determined to be favorable, calculating the compensation for the portfolio manager using a first equation, the first equation being a function of the calculated difference between the return of the managed portfolio against the reference return;
d) if the return of the managed portfolio is determined to be unfavorable, calculating the compensation for the portfolio manager using a second equation, the second equation being a function of the calculated difference between the return of the managed portfolio against the reference return, wherein the second equation has a lower rate of compensation than the first equation.

4. The method according to claim 3, wherein the favorable return is based on the calculated difference exceeding a predetermined percentage.

5. The method according to claim 3, wherein the unfavorable return is based on the calculated difference being less than a predetermined percentage.

6. The method according to claim 3, wherein the reference return is an investment index.

7. The method according to claim 3, wherein the unfavorable return is based on the calculated difference being negative.

8. The method according to claim 3, wherein the predefined time period is selected from a group consisting of: minutes, hours, days, weeks, months, and years.

9. The method according to claim 3, wherein the first and second equations are selected from the group consisting of; linear, quadratic, power, logarithmic, and inverse.

10. The method according to claim 3, wherein the first and second equations have the same functional form.

11. The method according to claim 3, wherein the first and second equations have different functional forms.

12. The method according to claim 3, further comprising at least one additional equation to calculate the compensation for the portfolio manager, said at least one additional equation being a function of the calculated difference between the return of the managed portfolio against the reference return.

13. The method according to claim 3, wherein the functional form of the first and second equations is linear.

14. The method according to claim 13, wherein the two slope coefficients are non-zero and different.

15. A method for aligning investor and portfolio manager interest having a fee algorithm comprising a first function that charges a higher fee to an investor when a portfolio return is favorable during a predefined time period and a second function that charges a lower fee to the investor when said portfolio return is not favorable during a predefined time period, said first function given by
(Fee)ᵢ=aᵢ+bᵢ(portfolio return−reference return)
and said second function given by
(Fee)ᵢᵢ=aᵢᵢ+bᵢᵢ(portfolio return−reference return)
wherein aᵢ, aᵢᵢ, bᵢᵢ and bᵢᵢ are coefficients of linear equations.

16. The method according to claim 15, wherein the favorable return is based on exceeding a predetermined percentage.

17. The method according to claim 15, wherein the unfavorable return is based on being less than a predetermined percentage.

18. The method according to claim 15, wherein the favorable return is based on said portfolio return exceeding the return of a predetermined reference investment.

19. The method according to claim 15, wherein the unfavorable return is based on said portfolio return being less than the return of a predetermined reference investment.

20. The method according to claim 15, wherein the predefined time period is selected from a group consisting of: minutes, hours, days, weeks, months, years.
